(19) United States
(12) Patent Application Publication
(10) Pub. No.: US 2025/0181776 A1
(43) Pub. Date: Jun. 5, 2025

(54) METHOD AND SYSTEM FOR CREATING A DISTRIBUTED LEDGER OF VERIFIED VEHICLE TRANSACTIONS

(71) Applicants: HUAWEI TECHNOLOGIES CANADA CO., LTD., Kanata (CA); The Governing Council of the University of Toronto, Toronto (CA)

(72) Inventors: Gengrui ZHANG, Toronto (CA); Hans-Arno JACOBSEN, Toronto (CA); Sheng SUN, Kanata (CA)

(73) Assignees: HUAWEI TECHNOLOGIES CANADA CO., LTD., Kanata, ON (CA); The Governing Council of the University of Toronto, Toronto, ON (CA)

(21) Appl. No.: 19/047,037

(22) Filed: Feb. 6, 2025

Related U.S. Application Data
(63) Continuation of application No. PCT/CA2022/051390, filed on Sep. 20, 2022.

(51) Int. Cl. G06F 21/64

(52) U.S. Cl. CPC G06F 21/64; G06F 2221/2151

(57) ABSTRACT

A distributed ledger for vehicle transactions is provided. Also provided is a method of validating vehicle transactions, a method of obtaining a consensus on vehicle transactions, a method of entering data into a distributed ledger and a method of logging vehicle transactions. For each transaction of vehicle transactions, an agreement on a timestamp of the transaction is obtained to form a set of agreed transactions. For the ordered group of the agreed transactions, a consensus on a validity of the group of agreed transactions is obtained. The methods and systems of the present disclosure are specifically designed to address the consensus problem in the context of V2X but may also serve to reach consensus in other contexts. Furthermore, it enables reaching consensus with low latency and high throughput, and dynamic membership changes. It also requires limited (less) memory use to store consensus results. In embodiments, the ordering and commit are separated in achieving consensus (allowing parallel ordering which is quicker, thus lower ordering latency and higher throughput).

### CROSS-REFERENCE TO RELATED APPLICATIONS

This application is a continuation of International Application No. PCT/CA2022/051390, filed on Sep. 20, 2022, the disclosure of which is hereby incorporated by reference in its entirety.

### TECHNICAL FIELD

The present disclosure pertains to the storage of data generated by vehicles and to keeping records of the generated data.

### BACKGROUND

Vehicles today are equipped with many sensors (e.g., cameras, radars, GPS, gyroscopes, etc.) that generate a vast amount of data that may be transmitted to and recorded at a centralized entity, e.g., a vehicle database owned by the vehicle manufacturer. The data may relate to vehicle speed, brake status, throttle position, etc. In certain instances, the data may be shared, by the vehicle manufacturer, with other external entities, for example, insurance companies for car accident claims. However, there is presently no way of verifying the authenticity of the data provided by the vehicle manufacturer. That is, if the data provided by the centralized entity were tampered data, there would be no way for someone outside the centralized entity to know. Because such centralized entities (e.g., vehicular databases) monopolize the data, a vehicle owner may not be able to access the stored data or become aware of any modification made to the data.

Therefore, there is a need for systems and methods that obviate or mitigate one or more limitations of the prior art.

This background information is provided to reveal information believed by the applicant to be of relevance to the present disclosure. No admission is necessarily intended, nor should be construed, that any of the preceding information constitutes prior art against the present disclosure.

### SUMMARY

An object of aspects of the present disclosure is to provide a decentralized consensus system for vehicular blockchain platforms.

In accordance with an aspect of the present disclosure, there is provided a method of validating vehicle transactions. In particular, the method includes: by a proposer vehicle, the proposer vehicle generating the vehicle transactions, for each transaction of the vehicle transactions, obtaining an agreement on timestamp data of the transaction, to obtain a set of agreed transactions. The step of obtaining the agreement on the timestamp data of the transaction includes: providing the timestamp data of the transaction to validators for validation of the timestamp data by the validators; obtaining, from a quorum of validators, respective validation messages indicating respective validations of the timestamp data; generating a digital signature in accordance with the validation messages; providing the digital signature to the quorum of validators; and receiving, from the quorum of validators, respective timestamp validity agreement messages indicating the agreement on the timestamp of the transaction.

In accordance with the embodiments, the method further includes: when the transaction is a first transaction, generating the set of agreed transactions with the first transaction being a first element of the set of agreed transactions; and when the transaction is a transaction subsequent the first transaction, appending the transaction to the set of agreed transactions to form an ordered set of agreed transactions.

In accordance with the embodiments, the method by the proposer vehicle further includes: identifying validator vehicles within a communication range of the proposer vehicle, to form a queue of identified validator vehicles; and selecting some of the identified validator vehicles as the validators.

In embodiments, the validators can include the proposer vehicle and a consensus pivot. The consensus pivot can be one of: a manufacturer of the proposer vehicle, an entity associated with the manufacturer of the proposer vehicle, an insurance company, and a government agency.

In embodiments, the timestamp data can include a timestamp of the transaction, a transaction, and a hash of the transaction. The transaction may include at least one of transaction data and a transaction description.

In embodiments, each of the validation messages is issued by a respective one of the validators after the respective one of the validators validates the timestamp of the transaction and the hash of the transaction.

Accordingly, in embodiments, providing timestamp data of the transaction to validators includes providing the timestamp data to 3f+1 validators, the quorum of validators is equal to 2f+1, and f is a positive integer number.

In embodiments, generating the digital signature can include generating the digital signature through a threshold signature scheme.

In embodiments, when the validators are first validators, the validation messages are first validation messages, and the digital signature is a first digital signature, the method can further include: selecting a group of ordered agreed transactions from the ordered set of agreed transactions; and obtaining a consensus on a validity of the group of ordered agreed transactions. The step of obtaining a consensus on the validity of the group of ordered agreed transactions includes: providing group timestamp data of the group of ordered agreed transactions to second validators for validation of the group timestamp data; obtaining, from a quorum of second validators, respective second validation messages indicating respective validations of the group timestamp data; generating a second digital signature in accordance with the second validation messages; providing the second digital signature to the quorum of second validators; and receiving, from the quorum of second validators, respective transaction group consensus messages indicating the consensus of the validity of the group ordered agreed transactions; and committing the group of ordered agreed transactions.

Accordingly, in embodiments, providing the group timestamp data of the group of ordered transactions to the second validators includes providing the group timestamp data to 3g+1 second validators, the quorum of second validators is equal to 2g+1, and g is a positive integer number.

In embodiments, the second validators include the proposer vehicle and an additional party. The additional party can be one of: the maker of the proposer vehicle, an insurance firm, and a government organization.

In embodiments, the proposer vehicle can include a first storage system and the additional party can include a second storage system. In accordance with the embodiments, the method further includes storing the group of ordered agreed transactions in the first storage system and in the second storage system.

In embodiments, when the first storage system includes a temporary storage and a permanent storage and storing the group of ordered agreed transactions in the first storage system includes storing the group of ordered agreed transactions in the temporary storage, the method can further include the proposer vehicle selecting transactions from the group of ordered agreed transactions to obtain selected transactions; and storing the selected transactions in the permanent storage.

Furthermore, the method can further include the proposer vehicle waiting for a pre-determined duration prior to selecting the transactions from the group of ordered agreed transactions to obtain the selected transactions.

In embodiments, selecting the transactions is performed in accordance with a pre-determined selection criteria.

In accordance with another aspect of the present disclosure, there is also provided a method of obtaining a consensus on vehicle transactions. In particular, the method includes: by a proposer vehicle generating the vehicle transactions, the proposer vehicle having associated thereto a group of vehicle transactions, the proposer vehicle providing group timestamp data of the group of vehicle transactions to validators for validation of the group timestamp data; obtaining, from a quorum of the validators, respective validation messages indicating respective validations of the group timestamp data; generating a digital signature in accordance with the second validation messages; providing the second digital signature to the quorum of the second validators; and receiving, from the quorum of the second validators, respective transaction group consensus messages indicating the consensus of the validity of the group ordered agreed transactions; saving the group of vehicle transactions at the proposer vehicle; and committing the group of ordered agreed transactions.

In embodiments, providing the group timestamp data of the group of vehicle transactions to the validators includes providing the group timestamp data to 3g+1 validators, the quorum of validators is equal to 2g+1, and g is a positive integer number.

In embodiments, the validators include the proposer vehicle and an additional party. The additional party can be one of: a manufacturer of the proposer vehicle, an insurance firm, and a government organization.

In embodiments, when the proposer vehicle includes a first storage system and the additional party includes a second storage system, the method can further include storing the group of ordered agreed transactions in the first storage system and in the second storage system.

Furthermore, when the first storage system includes a temporary storage and a permanent storage and storing the group of ordered agreed transactions in the first storage system includes storing the group of ordered agreed transactions in the temporary storage, the method can further include the proposer vehicle: selecting transactions from the group of ordered agreed transactions to obtain selected transactions; and storing the selected transactions in the permanent storage.

In embodiments, the method can further include the proposer vehicle waiting for a pre-determined duration prior to selecting the transactions from the group of ordered agreed transactions to obtain the selected transactions.

In embodiments, selecting the transactions is performed in accordance with a pre-determined selection criteria.

In accordance with another aspect of the present disclosure, there is also provided a method of entering data into a distributed ledger. The method comprises obtaining a consensus on vehicle transactions, obtaining the consensus comprising, by a proposer vehicle generating the vehicle transactions, the proposer vehicle having associated thereto a group of vehicle transactions. The proposer vehicle provides group timestamp data of the group of vehicle transactions to validators for validation of the group timestamp data. The proposer vehicle also obtains, from a quorum of the validators, respective validation messages indicating respective validations of the group timestamp data, the quorum of validators including the proposer vehicle. The proposer vehicle generates a digital signature in accordance with the second validation messages and provides the second digital signature to the quorum of the second validators. The proposer vehicle receives, from the quorum of the second validators, respective transaction group consensus messages indicating the consensus of the validity of the group ordered agreed transactions. The method also comprises saving the group of vehicle transactions at each validator of the group of validators, each instance of saved group of vehicle transactions at each validator forming the distributed ledger and committing the group of ordered agreed transactions.

In embodiments, the quorum of validators includes at least two additional vehicles and at least one of a manufacturer of the proposer vehicle, an insurance firm, and a government organization.

In accordance with another aspect of the present disclosure, there is also provided a method of logging vehicle transactions. In particular, the method includes: by a vehicle generating the vehicle transactions, for each transaction of the vehicle transactions, obtaining an agreement on a timestamp of the transaction, to obtain a set of agreed transactions; and for the ordered group of the agreed transactions, obtaining a consensus on a validity of the group of agreed transactions. Accordingly, for each transaction of the vehicle transactions, the step of obtaining the agreement on the timestamp of the transaction includes: providing timestamp data of the transaction to first validators for validation of the timestamp data by the validators; obtaining, from a quorum of first validators, respective first validation messages indicating respective validations of the timestamp data; generating a first digital signature in accordance with the first validation messages; providing the first digital signature to the quorum of first validators; receiving, from the quorum of first validators, respective timestamp validity agreement messages indicating the agreement on the timestamp of the transaction; and appending the transaction to the set of agreed transactions to form an ordered group of the agreed transactions. Furthermore, for the ordered group of the agreed transactions, the step of obtaining a consensus on the validity of the group includes: providing group timestamp data of the group of agreed transactions to second validators for validation of the group timestamp data; obtaining, from a quorum of second validators, respective second validation messages indicating respective validations of the group timestamp data; generating a second digital signature in accordance with the second validation messages; providing the second digital signature to the quorum of second validators; and receiving, from the quorum of second validators, respective transaction group consensus messages indicating the consensus of the validity of the group of transactions; and committing the group of transactions in a ledger of the vehicle.

Embodiments of the present disclosure may provide technical advantages or benefits. First, it is specifically designed to solve the consensus problem in the context of V2X. Second, it enables reaching consensus with low latency and high throughput (e.g., less message-passing in the network and saving bandwidth to propose more transactions). Third, it also enables dynamic membership changes. Fourth, it requires limited (less) memory use to store consensus results. Fifth, the ordering and commit are separated in achieving consensus (allowing parallel ordering which is quicker, thus lower ordering latency and higher throughput).

### BRIEF DESCRIPTION OF THE DRAWINGS

Further features and advantages of the present disclosure will become apparent from the following detailed description, taken in combination with the appended drawings, in which;

FIG. 1 shows an embodiment of a system in accordance with the present disclosure

FIG. 2 shows a flowchart of an embodiment of a method in accordance with the present disclosure.

FIG. 3 shows a flowchart of another embodiment of a method in accordance with the present disclosure.

FIG. 4 shows an embodiment of a set or ordered validated transactions in accordance with the present disclosure.

FIG. 5 shows an embodiment of a storage system in accordance with the present disclosure.

It will be noted that throughout the appended drawings, like features are identified by like reference numerals.

### DETAILED DESCRIPTION

“Vehicle-to-Everything (V2X)” refers to communication between a vehicle and other entities. V2X includes specific types of communication such as Vehicle-to-Vehicle (V2V), Vehicle-to-Infrastructure (V2I), Vehicle-to-Pedestrian (V2P), etc. For example, multiple V2X-enabled vehicles may coordinate their movements on the road to increase safety and fuel efficiency, based on reliable communication between vehicles.

In relation to the present disclosure, the terms “client request”, “request”, “data”, “transaction”, and “value” may be used interchangeably hereinafter.

Unless defined otherwise, all technical and scientific terms used herein have the same meaning as commonly understood by one of ordinary skill in the art to which this disclosure belongs.

It is noted that permissioned blockchains can attain a higher throughput and lower latency by only allowing specific authenticated participants or nodes to participate in the consensus process. The primary concern of permissioned blockchains is to generate trust in an a priori trustless environment.

Accordingly, a blockchain consensus algorithm can be used to ensure that all participants/nodes in the system can agree on a single source of “truth”, even if some participants/nodes fail. In other words, a blockchain consensus algorithm (e.g., a BFT consensus algorithm) provides a decentralized mechanism including a shared database to allow vehicles to validate data they receive in a trustless manner.

The present disclosure provides a method and system for reaching a consensus on transactions taking place in a vehicle and for committing the transactions to a distributed ledger. In this method and system, the vehicle in which the transactions are taking place provides the transactions, on a transaction per transaction basis, to a first set of validators, which include the vehicle itself, other vehicles and a third party such as, for example, the vehicle manufacturer, an entity associated with the vehicle manufacturer, an insurance company, a government agency, etc. The validators review and validate the transactions. The vehicle associated with the validated transaction provides groups of ordered validated transactions to a second set of validators. The validators of the second set of validators reach a consensus on the validity of the groups of ordered transactions, which are then committed to storage in a respective memory of each validator of the second set of validators.

Thus, the present disclosure relates to establishing a multi-party consensus on transactions occurring in a vehicle. Examples of such transactions include creating a record in a database, amending a record in a database, and deleting a record in a database. The record may relate to data generated by sensors, systems or sub-systems comprised in the vehicle.

The consensus approach of the present disclosure breaks the vehicle manufacturers' monopoly of vehicle data in traditional systems. As previously mentioned, in such centralized systems, data is collected from individual vehicles and stored in databases to which the vehicle owners do not have access.

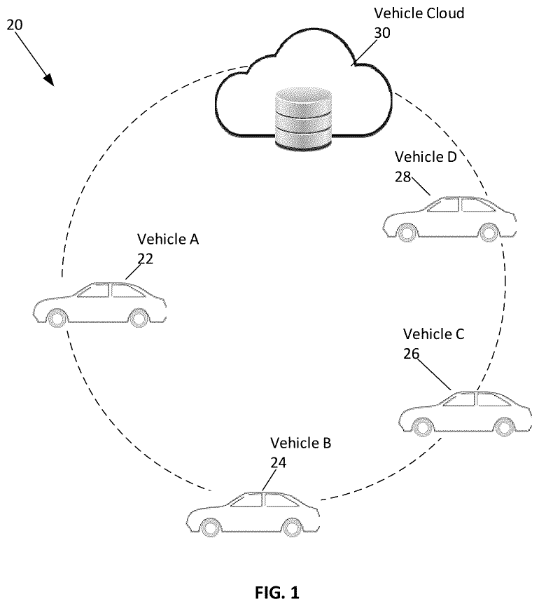

FIG. 1 shows a system 20 according to an embodiment of the present disclosure. The system 20 may include multiple vehicles such as vehicle A 22, vehicle B 24, vehicle C 26 and vehicle D 28. The system 20 includes an entity associated with a vehicle manufacturer, which may be a vehicle cloud 30, which, in this embodiment, is associated with the manufacturer of vehicle A 22. Vehicle A 22 is coupled to vehicles B, C and D (24, 26 and 28) and to the vehicle cloud 30. That is, vehicle A 22 may communicate and exchange data, through any suitable communication technology (e.g., wireless technology), with vehicles B, C and D (24, 26 and 28) and with the vehicle cloud 30.

In operation, the system 20 allows for transactions occurring in vehicle A to be reviewed by other vehicles and by the vehicle cloud 30, and to be validated by a quorum of the vehicles and the vehicle cloud 30. All the validated transactions may be stored in the vehicle cloud 30. Some of the validated transactions may be identified as important transactions and stored in a permanent storage of the vehicle A 22 and in other vehicles. As such, at least vehicle A 22 and the vehicle cloud 30 will permanently store the important validated transactions of vehicle A 22, thereby allowing, if need be, the user of vehicle A 22 to verify the accuracy of the important transactions stored at the vehicle cloud 30.

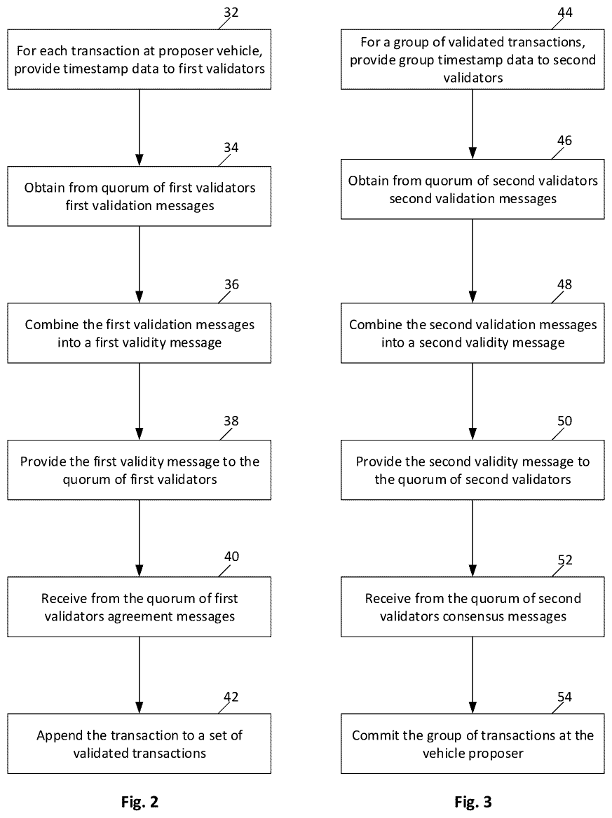

In accordance with the present disclosure, FIG. 2 shows a flowchart of an embodiment of method of validating transactions generated at a vehicle and agreeing on an order of the validated transactions. The method shown at FIG. 2 may include the following actions.

At action 32, vehicle A 22, which has generated a transaction, provides timestamp data associated with the transaction to first validators. In some embodiments, the timestamp data may include a timestamp (logical timestamp) of the transaction, the transaction (a description of the transaction, data generated by the transaction, entries of the transaction, etc.) and a hash of the transaction. In this embodiment, the first validators include vehicle A 22, which is referred to as the proposer (of the transaction), vehicle B 24 and vehicle C 26, and the vehicle cloud 30. Defining the timestamp as being t, the transaction as being tx, and the hash of the transaction as being htx, vehicle A 22 may provide the timestamp data to the first validators in a post message of the form <t, tx, htx>. The post message may also include a signature that identifies vehicle A 22 (the proposer) to the first validators.

At action 34, after each of the first validators has attempted to validate the transaction, vehicle A 22 obtains from a quorum of the first validators, first validation messages. Each of the first validation messages may include a unique identification (ID) of the respective validator. The identification may be a digital signature of the respective validator. Each validation message may be in the form <t, htx, ID>.

To validate the timestamp data <t, tx, htx>, each first validator that may have previously acted as a validator for transactions from the vehicle A 22 verifies that the timestamp received from the vehicle A 22 was not previously received from the vehicle A 22 and may also verify that the timestamp is not earlier than any timestamp previously received from the vehicle A 22. To validate a transaction, each first validator may compute the hash of tx to ensure it matches the hash received from the vehicle A 22.

The quorum of first validators may be predefined in any suitable manner. For example, in some embodiments, an administrator of the system 20 may decide that four of the five nodes (i.e., four of: vehicle cloud 30, vehicle A 22, vehicle B 24, vehicle C 26, and vehicle D 28) act as validators of transactions and that 1 fault f in the system may be tolerated. Accordingly, the administrator may set the quorum to 2f+1=3 nodes. In an example where the administrator decides that all five nodes of the system 20 are to act as transaction validators, the nominal number of faults that may be tolerated would be based on the floor function ƒ (n)=└(n−1)/3┘ for n=5, which equals ƒ (5)=└(5−1)/3┘=1. A system with seven nodes acting as validators would be able to tolerate ƒ (7)=└(7−1)/3┘=2 faults.

In some embodiments, for the transaction to be validated, the quorum of first validators must include the proposer (vehicle A 22) of the transaction and a specific validator (e.g., the vehicle cloud 30). That is, independently from obtaining a quorum of first validators, the transaction may only be validated when the proposer and the specific validator validate the transaction.

At action 36, vehicle A 22 may combine the validation messages received from each first validator of the quorum, into a first validity message R and provide the first validity message R to each first validator of the quorum of the first validators. The first validity message R may be a combined digital signature generated based on at least the digital signatures of the first validators of the quorum. The combined digital signature may be generated in any suitable manner such as, for example, a threshold signature scheme. The first validity message R may be provided to the first validators of the quorum of first validators in a post message of the form <t, htx, R>.

At action 38, the first validity message R may be provided to the first validators of the quorum of first validators in a post message of the form <t, htx, R>. The first validators of the quorum may thus verify that the transaction has been validated by a quorum of first validators and lock the timestamp for the transaction, i.e., identify the timestamp as being a previously used timestamp of the proposer (vehicle A 22).

Subsequently, at action 40, the vehicle A 22 may obtain from each first validator of the quorum of first validators, a respective agreement message indicating that each validator of the quorum of first validators agrees on the timestamp of the transaction (the order of the transaction) and on the transaction itself.

At action 42, the validated transaction is appended to a set of previously validated (agreed) transactions. As each transaction is validated in the order the transaction occurred at vehicle A 22, the set of validated transactions is an ordered set of validated transactions.

Because the ordering of transactions occurs on a transaction-by-transaction basis, the ordering of multiple transactions may occur in parallel or concurrently.

The present disclosure also provides a method and system that allows validators to reach an agreement (consensus) on individual groups of transactions and to commit the transactions on a group-by-group basis rather than on a transaction-by-transaction basis. This may be referred to as a consensus phase (a consensus process) of embodiments of the present disclosure. In embodiments of the present disclosure, the process of agreeing (reaching a consensus) on individual groups of transactions and committing groups of transactions may be carried out based on any suitable policy. Examples of such policies may include, for example, launching the consensus process at pre-determined time intervals, launching the consensus process when the sum of memory occupied by timestamp data meets a pre-determined volume, launching the consensus process when a pre-determined number of validated ordered transactions is met, etc. The separation of the validating/ordering process from the consensus process allows such processes to be executed in parallel, thereby increasing throughput and decreasing ordering latency.

In accordance with the present disclosure, FIG. 3 shows a flowchart of an embodiment of method of reaching a consensus on individual groups of transactions, i.e., a method of validating groups of ordered validated transactions. The method shown at FIG. 3 may include the following actions.

At action 44, vehicle A 22, which has generated an ordered set of validated transactions, provides, for a group of ordered validated transactions from the ordered set of validated transactions, group timestamp data to second validators. The group timestamp data may be stored at all the second validators. The second validators may be different from the first validators; however, in some embodiments, the second validators must include the proposer (vehicle A 22) and another specific third-party validator (e.g., the vehicle cloud 30).

In some embodiments, the group timestamp data may include a timestamp (logic timestamp) for a group of ordered validated transactions selected from the set of ordered validated transactions, the transactions in the group and a hash of each transaction in the group. In this embodiment and referring to FIG. 1, the second validators may include vehicle A 22, which is the proposer (of the group of ordered validated transactions), vehicle B 24, vehicle D 28 and the vehicle cloud 30.

The group timestamp may be based on a clock different from the clock that timestamps individual transactions. The group timestamps may be written as ct_1, ct_2, ct_3, . . . , ct_n. Each group timestamp is associated with a group of ordered validated transactions from the set of ordered validated transactions. As an example, a group timestamp ct_k may be associated with transactions tx_i to tx_j, with i, j and k being positive integers.

In accordance with the present disclosure, FIG. 4 shows an embodiment of a set 60 of ordered validated transactions (t1, t2, t3, t4, t8, t11, etc.) Also shown in FIG. 4 is group 62, which comprises transactions t1, t2, t3, t4, 18, t11 and t12; group 64, which comprises transactions t17, t18, t19, t20, t23, t24 and t26; and group 66, which comprises transactions t27, t28, t29, t31, t32, t33 and t34. Group 62 is associated with ct_1, group 64 with ct_2, and group 66 with ct_3. In the example of FIG. 4, each of group 60, group 62 and group 64 include a same number of transactions, the number being seven. This need not be the case. Each group may comprise any suitable number of transactions. The group timestamp data provided by vehicle A 22 to the second validators may be provided in a message of the form <ct_k, (tx_i, . . . ,tx_j), (htx_i, . . . , htx_j)>, where htx_i (htx_j) is the hash of transaction tx_i (tx_j). For example, the message may be <ct_2, (t17, t18, t19, t20, t23, t24, t26), (ht17, ht18, ht19, ht20, ht23, ht24, ht26)>.

At action 46, after each of the second validators has attempted to validate transactions of the group of ordered validated transactions, vehicle A 22 obtains from a quorum of the second validators, second validation messages. Each of the second validation message may include a digital signature of the respective second validator. The second validation message may have the form <ct_i, agreed, ID> to indicate the validation of the transactions associated with group timestamp ct_i.

To validate the group timestamp data, each second validator that may have previously acted as a validator for groups of ordered validated transactions from vehicle A 22 verifies that the group timestamp received from the vehicle A 22 was not previously received from the vehicle A 22 and may also verify that the group timestamp is not earlier than any group timestamp previously received from the vehicle A 22. Additionally, to validate each transaction of the group, each second validator may compute the hash of tx to ensure it matches the respective hash received from the vehicle A 22.

The quorum for validating groups of transactions may be predefined in any suitable manner. For example, in some embodiments, the system 20 may have decided that 1 fault f in the system could be tolerated and has set the quorum to 2f+1=3. In some embodiments, the quorum for validating groups of transactions may be different from the quorum required to validate individual transactions.

At action 48, the vehicle A 22 may combine the second validation messages into a second validity message (denoted by R_C) and provide the second validity message to each second validator of the quorum of second validators. The second validity message may be a combined digital signature generated based on at least the digital signatures of the second validators of the quorum of first validators. The combined digital signature may be generated in any suitable manner such as, for example, a threshold signature scheme.

At action 50, vehicle A 22 may provide the second validity message to the second validators of the quorum of second validators. Vehicle A 22 may provide the second validity message to the quorum of second validators in a message of the form <ct_k, R_C>.

Subsequently, at action 52, vehicle A 22 may obtain from each validator of the quorum of second validators, a respective agreement message indicating that each validator agrees the group of ordered validated transactions has been validated by a quorum of second validators.

At action 54, the transactions of the group of ordered validated transactions may be stored and committed at the proposer (vehicle A 22) and at the second validators of the quorum of second validators.

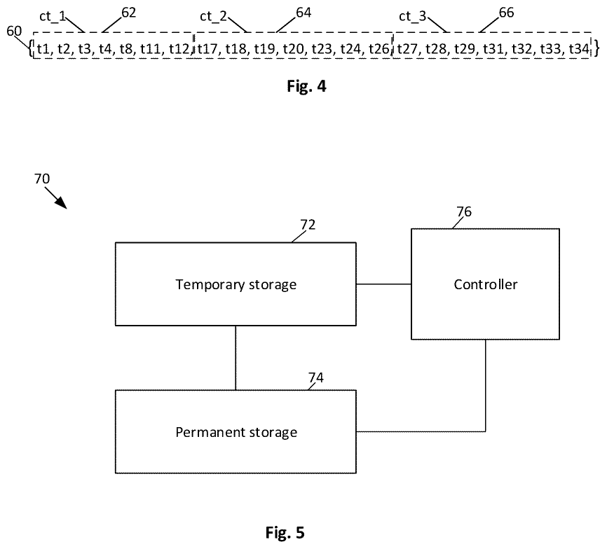

In embodiments of the present disclosure, the transactions in the validated groups of ordered validated transactions may be stored in a storage system of the proposer that comprises a temporary storage and a permanent storage. An embodiment of such a storage system 70, in accordance with the present disclosure, is shown at FIG. 5. The storage system 70 comprises a temporary storage 72, a permanent storage 74 and a controller 76 coupled to the temporary storage 72 and to the permanent storage 74. Each validator other than the proposer also has its own storage 70. The entity associated to the manufacturer of the proposer's vehicle may have its own storage system 70 or may have only a permanent storage system (not shown).

The controller 76 is configured to have the validated groups of ordered validated transactions stored in the temporary storage 72 on a group-by-group basis. The controller 76 may also be configured to identify as “important” some of the transactions that are part of the groups of transactions stored in the temporary storage 72 and cause the “important” transactions to be stored in the permanent storage 74. Subsequent storing the “important” transactions being stored in the permanent storage 74, the “important” transactions and the transactions not deemed “important” may be deleted from the temporary storage 72. The controller 76 may be configured to carry out the above steps in accordance with pre-defined classes of “important” transactions at fixed time intervals (e.g., 24 hours) or in response to user-issued commands. The classes of “important” may be defined by the vehicle manufacturer or by the owner of the proposer vehicle or by both.

In some embodiments, the same transactions stored in the proposer's temporary storage 72 may also so be stored in the validator vehicles that were part of the quorum that validated groups of ordered validated transactions. The storage system of the validator vehicles may transfer the “important” transactions to their permanent storage according to preset rules that may be defined by the manufacturer of the proposer vehicle, by the owner of the validator vehicle, or by both. The storage system of the vehicle manufacturer may store all the transaction of the proposer vehicle or only the important transactions, or both.

In the event where the validator vehicles fail to store the important transactions of the proposer vehicle, there will still exist two permanent records of the important transactions: one at the proposer vehicle and one at the vehicle manufacturer's storage system.

As described above, a single participant (i.e., only one proposer) proposes transactions and coordinates the validation of the transactions on a transaction-by-transaction basis; the proposer also coordinates obtaining a consensus on individual groups of ordered validated transactions. That is, only the transaction proposer proposes and broadcasts transactions. The other participating units, i.e., the other vehicles and the entity associated with the manufacturer of the proposer, are validators. The validators, other than the proposer, receive individual transactions or groups of ordered validated transactions. The entity associated with the manufacturer of the proposer (e.g., the manufacturer of vehicle A) may be referred to as the consensus pivot. In some embodiments, the consensus pivot may be the vehicle manufacturer (maker) itself, an entity associated with the vehicle manufacturer, an insurance company, a government agency, etc. In some embodiments, the consensus pivot may store all the transactions.

In embodiments of the present disclosure, each transaction generated by the proposer and each group of ordered validated transaction generated by the proposer must be validated by the same proposer and by the consensus pivot. The other validators (i.e., the participating vehicle validators) can change dynamically during the consensus process (as vehicles can go online and offline at any given time), thus resulting in a dynamic quorum instead of a fixed one. That is, there may be different vehicle validators validating individual transactions and different vehicle validators validating groups of ordered validated transactions. For example, there may be a first ensemble of vehicles surrounding the proposer vehicle at the time of validating an individual transaction but there may be a different ensemble of vehicles surrounding the proposer vehicle at the time of validating a group of ordered validated transactions. The proposer may select vehicle validators in any suitable manner. For example, the proposer vehicle may keep a running list of surrounding vehicles to which it is connected or to which it may connect and select/replace validator vehicles as they are needed, according to the running list.

In prior art transaction validating approaches, each transaction is committed immediately after ordering. However, in embodiments of the present disclosure, the ordering of a transaction is separate the committing the transaction. For example, given n transactions, existing approaches perform an ordering of the first transaction and will then immediately commit the first transaction, which is followed by ordering the second transaction, committing the second transaction, ordering the third transactions, etc. until all the n transactions are committed. In contrast, in embodiments of the present disclosure, several transactions are validated (ordered) on a transaction-by-transaction basis prior to committing a group of ordered validated transactions.

The system and method of the present disclosure may be designed to enable flexible storage for each participating vehicle. Each vehicle may contain two layers of storage with one layer storing temporary data, and the other layer storing permanent data. Each vehicle may store a record of all the important transactions of all the vehicles for which it acted as a validator.

Embodiments of the system and method of the present disclosure may provide a solution to shift from centralized to decentralized systems by forming consensus for each data transaction among a group of independent vehicles (as shown in FIG. 1). The system and method of the present disclosure avoids data monopoly and builds a trustworthy network via joint consensus from participating vehicles.

The system and method of the present disclosure may be configured to reach and attain consensus and agreement in a low-latency and high-throughput manner among several vehicles (mobile nodes), where some or all the mobile nodes may be resource constrained. The system and method of the present disclosure enables dynamic membership changes within a quorum. A limited memory resource (rather than massive permanent memory resource) is required to store the consensus results. Furthermore, the ordering phase and the commit/consensus phase are separated in achieving consensus.

After the consensus phase, vehicles store the consensus results into a two-layer storage system (e.g., fixed-size storage). The two layers are the temporary and permanent storage layers. Transactions are stored in the temporary layer by default. If it is necessary or required to keep some transactions for future use, a user can select transactions to be transferred to and stored in the permanent storage layer (e.g., by user-specific instructions).

The temporary storage layer may operate under user-defined policies that define each stored transaction's lifetime (also referred to as “a preset waiting period” for transferring data from the temporary layer to the permanent layer). For example, the policy may be defined as “x-hour storage”, i.e., a transaction stored in this layer has a lifetime of x hours. After x hours, the transaction will be deleted.

The permanent storage layer stores user-selected transactions (“important” transactions) from the temporary storage layer. Users can select transactions in the temporary storage to permanently store them in the permanent storage layer. Transactions stored in the permanent layer may not be affected by the user-defined policies in the temporary storage layer.

For example, a typical preset waiting time would be 24 hours (e.g., if a user does not select data to be transferred from the temporary layer to the permanent layer, the data can be automatically erased after 24 hours, then the storage space on the temporary layer will be released to store new data). In a practical scenario, each committed transaction is signed by the participating validators at that time in the consensus process. Even if the proposer vehicle and the validator vehicles never cross path again, the validators' signatures are still stored by the proposer and the consensus pivot(s). No one can forge their signatures (i.e., these signatures indicate that the consensus result is legit). If the validators no longer participate in the consensus process with the proposer, then the validators will clean up their temporary storage after the defined period, e.g., 24 hours. In other words, only the consensus pivot(s) and proposer have the transactions if the validators disappear after the consensus phase.

It is noted that the data or memory storage is maintained by both the vehicle itself and the cloud server (of the vehicle manufacturer or of a third party). All the transactions of the vehicle (important or unimportant) may be stored in the cloud platform (consensus pivot). In some embodiments, vehicle validators may also permanently store only important transactions.

In some embodiments, the pivot, proposer, and validators temporarily store all transactions unless a user/application gives specific instructions to put temporarily stored transactions into permanent storage. When a user triggers a command to identify some transactions as important transactions and wants to store them permanently, then these transactions become the important transactions, and pivot, proposer, and validators store these transactions (important transactions) permanently. These transactions are totally ordered by the V-Guard consensus algorithm before they are stored in each pivot/proposer/validator. The storage layer, which contains the totally ordered transactions, already is a blockchain. A blockchain is simply a (distributed) ledger (i.e., a storage data structure) that consists of and maintains a total order of transactions. Each of the pivot, the proposer and validator keep the same order of transactions, and each of them maintains the same record of the transactions.

To summarize the above aspects, the present disclosure may provide various technical advantages or benefits. Firstly, the system and method of the present disclosure is specifically designed to solve the consensus problem in the context of V2X. Second, it enables reaching consensus with low latency and high throughput (e.g., less message-passing in the network and saving bandwidth to propose more transactions). Third, it also enables dynamic membership changes. Fourth, it requires limited (less) memory use to store consensus results. Fifth, the ordering and commit are separated in achieving consensus (allowing parallel ordering which is quicker, thus lower ordering latency and higher throughput).

As previously illustrated, in an aspect of embodiments of the present disclosure, the ordering phase of a transaction is separate from the consensus phase of the transaction. The ordering phase is promptly initiated when a vehicle generates a transaction, whereas the consensus phase periodically conducts consensus for a batch of ordered transactions. The two phases aim to increase throughput and decrease latency.

Notably, an alternative approach that does not separate the ordering and consensus phases can also be applied to achieve the same functionality or result.

In an approach that coalesce the two phases (i.e., the two phases come together for each transaction), the two phases are no longer separated, and each transaction has an ordering phase and a consensus phase. However, by doing so, there are more circulating messages needed as the consensus phase treats each transaction as a batch. This may increase latency and decrease throughput compared to the approach illustrated in the previous aspect where the two phases are separated.

Furthermore, the storage system may be replaced by a simpler approach without the two-layer storage design (i.e., only ONE permanent storage layer). An alternative approach that applies only one permanent storage layer may also achieve the same functionality as all transactions are stored permanently. However, this requires more memory consumption along with a growing number of proposed transactions, which increases the cost of hardware equipment and maintenance.

The foregoing aspects of the disclosure are examples and can be varied in many ways. Such present or future variations are not to be regarded as a departure from the spirit and scope of the disclosure, and all such modifications as would be obvious to one skilled in

What is claimed is:

1. A method of validating vehicle transactions, the method comprising:
by a proposer vehicle, the proposer vehicle generating the vehicle transactions, for each transaction of the vehicle transactions, obtaining an agreement on timestamp data of the transaction, to obtain a set of agreed transactions, obtaining the agreement on the timestamp data of the transaction including:
providing the timestamp data of the transaction to validators for validation of the timestamp data by the validators;
obtaining, from a quorum of validators, respective validation messages indicating respective validations of the timestamp data;
generating a digital signature in accordance with the validation messages;
providing the digital signature to the quorum of validators; and
receiving, from the quorum of validators, respective timestamp validity agreement messages indicating the agreement on the timestamp of the transaction.

2. The method of claim 1, further comprising:
when the transaction is a first transaction, generating the set of agreed transactions with the first transaction being a first element of the set of agreed transactions; and
when the transaction is a transaction subsequent the first transaction, appending the transaction to the set of agreed transactions to form an ordered set of agreed transactions.

3. The method of claim 1, further comprising, by the proposer vehicle:
identifying validator vehicles within a communication range of the proposer vehicle, to form a queue of identified validator vehicles; and
selecting some of the identified validator vehicles as the validators.

4. The method of claim 3, wherein the validators include the proposer vehicle and a consensus pivot, the consensus pivot being one of a manufacturer of the proposer vehicle, an entity associated with the manufacturer of the proposer vehicle, an insurance company, and a government agency.

5. The method of claim 1, wherein the timestamp data includes a timestamp of the transaction, a transaction, and a hash of the transaction, the transaction including at least one of transaction data and a transaction description.

6. The method of claim 5, wherein each of the validation messages is issued by a respective one of the validators after the respective one of the validators validates the timestamp of the transaction and the hash of the transaction.

7. The method of claim 1, wherein:
providing the timestamp data of the transaction to validators includes providing the timestamp data to 3f+1 validators,
the quorum of validators is equal to 2f+1, and
f is a positive integer number.

8. The method of claim 1, wherein generating the digital signature includes generating the digital signature through a threshold signature scheme.

9. The method of claim 2, wherein:
the validators are first validators,
the validation messages are first validation messages, and
the digital signature is a first digital signature, the method further comprising:
selecting a group of ordered agreed transactions from the ordered set of agreed transactions; and
obtaining a consensus on a validity of the group of ordered agreed transactions, obtaining a consensus on the validity of the group of ordered agreed transactions including:
providing group timestamp data of the group of ordered agreed transactions to second validators for validation of the group timestamp data;
obtaining, from a quorum of second validators, respective second validation messages indicating respective validations of the group timestamp data;
generating a second digital signature in accordance with the second validation messages;
providing the second digital signature to the quorum of second validators;
receiving, from the quorum of second validators, respective transaction group consensus messages indicating the consensus of the validity of the group ordered agreed transactions;
and
committing the group of ordered agreed transactions.

10. The method of claim 9, wherein:
providing the group timestamp data of the group of ordered transactions to the second validators includes providing the group timestamp data to 3g+1 second validators,
the quorum of second validators is equal to 2g+1, and
g is a positive integer number.

11. The method of claim 9, wherein the second validators include the proposer vehicle and an additional party, the additional party being at least one of the maker of the proposer vehicle, an insurance firm, and a government organization.

12. A method of obtaining a consensus on vehicle transactions, the method comprising, by a proposer vehicle generating the vehicle transactions, the proposer vehicle having associated thereto a group of vehicle transactions, the proposer vehicle:
providing group timestamp data of the group of vehicle transactions to validators for validation of the group timestamp data;
obtaining, from a quorum of the validators, respective validation messages indicating respective validations of the group timestamp data;
generating a digital signature in accordance with the second validation messages;
providing the second digital signature to the quorum of the second validators; and
receiving, from the quorum of the second validators, respective transaction group consensus messages indicating the consensus of the validity of the group ordered agreed transactions;
saving the group of vehicle transactions at the proposer vehicle; and
committing the group of ordered agreed transactions.

13. The method of claim 12, wherein:
providing the group timestamp data of the group of vehicle transactions to the validators includes providing the group timestamp data to 3g+1 validators,
the quorum of validators is equal to 2g+1, and
g is a positive integer number.

14. The method of claim 12, wherein the validators include the proposer vehicle and an additional party, the additional party being at least one of a manufacturer of the proposer vehicle, an insurance firm, and a government organization.

15. The method of claim 12, wherein the proposer vehicle comprises a first storage system and the additional party comprises a second storage system, the method further comprising storing the group of ordered agreed transactions in the first storage system and in the second storage system.

16. The method of claim 15, wherein:
the first storage system comprises a temporary storage and a permanent storage, and storing the group of ordered agreed transactions in the first storage system includes storing the group of ordered agreed transactions in the temporary storage;
the method further comprising the proposer vehicle:
selecting transactions from the group of ordered agreed transactions to obtain selected transactions; and
storing the selected transactions in the permanent storage.

17. The method of claim 16, further comprising the proposer vehicle waiting for a pre-determined duration prior to selecting the transactions from the group of ordered agreed transactions to obtain the selected transactions.

18. The method of claim 16, wherein selecting the transactions is performed in accordance with a pre-determined selection criteria.

19. A method of entering data into a distributed ledger, the method comprising:
obtaining a consensus on vehicle transactions, obtaining the consensus comprising, by a proposer vehicle generating the vehicle transactions, the proposer vehicle having associated thereto a group of vehicle transactions, the proposer vehicle:
providing group timestamp data of the group of vehicle transactions to validators for validation of the group timestamp data;
obtaining, from a quorum of the validators, respective validation messages indicating respective validations of the group timestamp data, the quorum of validators including the proposer vehicle;
generating a digital signature in accordance with the second validation messages;
providing the second digital signature to the quorum of the second validators; and
receiving, from the quorum of the second validators, respective transaction group consensus messages indicating the consensus of the validity of the group ordered agreed transactions; and
saving the group of vehicle transactions at each validator of the group of validators, each instance of saved group of vehicle transactions at each validator forming the distributed ledger; and
committing the group of ordered agreed transactions.

20. The method of claim 19, wherein the quorum of validators includes at least two additional vehicles and at least one of a manufacturer of the proposer vehicle, an insurance firm, and a government organization.
